(19) United States
(12) Patent Application Publication
(10) Pub. No.: US 2013/0189023 A1
(43) Pub. Date: Jul. 25, 2013

(54) APPARATUS AND METHODS FOR JOINING DISSIMILAR MATERIALS

(71) Applicant: ALCOA INC., Pittsburgh, PA (US)

(72) Inventor: Donald J. Spinella, Greensburg, PA (US)

(73) Assignee: ALCOA INC., Pittsburgh, PA (US)

(21) Appl. No.: 13/722,777

(22) Filed: Dec. 20, 2012

Related U.S. Application Data
(60) Provisional application No. 61/578,634, filed on Dec. 21, 2011.

(51) Int. Cl. B23K 11/00

(52) U.S. Cl. CPC B23K 11/002
USPC 403/270; 219/118

(57) ABSTRACT

An apparatus is provided including: at least one first sheet comprising a first material; at least one second sheet comprising a second material, wherein the first material comprises at least one of: a thermal conductivity and an electrical conductivity that is at least 10% lower than that of the second material; and a joint comprising at least one resistance spot weld (RSW), wherein the first sheet is at least about 1.5 times the thickness of the second sheet. Methods are also provided.

### CROSS-REFERENCE TO RELATED APPLICATIONS

This application claims priority to U.S. Application Ser. No. 61/578,634, entitled “Apparatus and Methods for Joining Dissimilar Materials” filed on Dec. 20, 2011, which is incorporated by reference in its entirety.

### BACKGROUND

Sheets of metallic materials are joined via welding techniques, typically resistance spot welding RSW. However, RSW is not possible with certain materials at certain thicknesses.

### SUMMARY

The instant disclosure provides various embodiments of directly welding (i.e. through resistance spot welding) certain materials together (e.g. aluminum alloy sheet to steel sheet or other sheet materials). Thus, the present disclosure employs methods of joining, including welding, to join sheet having a thickness of less than about 7 mm (e.g. less than about 6.5 mm minimum sheet gauge). In one aspect of the present disclosure, an apparatus is provided. In some embodiments, the apparatus comprises: a first sheet of a first material; a second sheet of a second material; and a joint comprising a plurality of resistance spot welds; wherein the first sheet is at least about 1.5 times the thickness of the second sheet.

In one method, resistance spot welded structures are comprised of sheet metal. Some structures include steel, while others include aluminum. Other processes of joining metals include brazing, soldering, upset butt, flash, cold/pressure, and gas metal arc welding.

In one aspect of the present disclosure, an apparatus is provided. In some embodiments, the apparatus comprises: a first sheet of a first material; a second sheet of a second material; and a joint comprising a plurality of resistance spot welds; wherein the first sheet is at least about 1.5 times the thickness of the second sheet.

In one aspect of the instant disclosure, an apparatus is provided, comprising: at least one first sheet comprising a first material; at least one second sheet comprising a second material, wherein the first material comprises at least one of: a thermal conductivity and an electrical conductivity that is at least 10% lower than that of the second material; and a joint comprising a RSW, wherein the first sheet is at least about 1.5 times the thickness of the second sheet.

In another aspect of the instant disclosure, an apparatus, comprising: at least one first sheet comprising an aluminum alloy; at least one second sheet comprising a non-aluminum material (e.g. Ti, Mg, Steel, Cu); and a joint comprising a resistance spot weld (RSW) configured to join the first sheet to the second sheet, wherein the thickness ratio of the first sheet to the second sheet is at least about 1.5.

In another aspect of the instant disclosure, an apparatus is provided, comprising: at least one first sheet of a first material; at least one second sheet of a second material, wherein the first material is different than the second material; and a joint comprising a plurality RSWs; wherein the first sheet is at least about 1.5 times the thickness of the second sheet.

In another aspect of the instant disclosure, an apparatus is provided, comprising: at least one first sheet of a first material; at least one second sheet of a second material, wherein the first material is different than the second material; and a joint comprising a plurality weld bonds (e.g. resistance spot weld bonds); wherein the first sheet is at least about 1.5 times the thickness of the second sheet.

In yet another aspect of the instant disclosure, an apparatus, comprising: at least one first sheet comprising an aluminum alloy; at least one second sheet comprising a copper-containing material, wherein the first material comprises at least one of: a thermal conductivity and an electrical conductivity that is at least 10% higher than that of the second material; and a joint comprising a RSW, wherein the first sheet is at least about 1.5 times the thickness of the second sheet.

In some embodiments, the weld has a cross-tension strength of at least about 2.67 kN when measured in accordance with JISZ3140.

In some embodiments, the aluminum material is selected from the group consisting of: AA series 1xxx; AA series 2xxx; AA series 3xxx; AA series 5xxx; AA series 6xxx; AA series 7xxx, or combinations thereof. In some embodiments, the aluminum material is selected from: Aluminum Association designation 5182; 5754; 6013; 6022; 7055; and 7075.

In some embodiments, the first sheet comprises a monolithic aluminum alloy. In some embodiments, the first sheet comprises a multi-layered aluminum alloy. Some non-limiting examples a layered aluminum alloy include: an Al—Si alloy, an Al—Si—Zn alloy, a coated aluminum alloy, a plated aluminum alloy, and/or a clad material (e.g. 6xxx or 3xxx series aluminum clad with a 4xxx series aluminum alloy like 4047; a 5xxx series aluminum alloy clad with a 1xxx or 7xxx series aluminum alloy; and a 2xxx series aluminum alloy sheet clad with a 1xxx, 6xxx, or 7xxx series aluminum alloy).

In some embodiments, the at least one first sheet comprises a plurality of sheets. In some embodiments, the at least one second sheet comprises a plurality of sheets. In some embodiments, the weld comprises a T2 weld (two sheets), a T3 weld (three sheets), a T4 weld (four sheets), a T5 weld (five sheets), a T6 weld (six sheets), a T7 weld (7 sheets), or more. In some embodiments, the joint comprises a 3T weld with one aluminum alloy sheet and two non-aluminum alloy sheets. In some embodiment, the joint comprises a 3T weld with two aluminum alloy sheets and 1 non-aluminum alloy sheet. In some embodiments, the 3T weld comprises different orientations of the two sheets respective of the one sheet (e.g. stacked 2:1, sandwiched between, etc).

In some embodiments, the thickness of the first sheet is not greater than about 5 mm.

In some embodiments, the thickness ratio of the first sheet to the second sheet is at least about 6:1.

In some embodiments, the apparatus comprises an auto structure, a body structure, or a closure panel. In some embodiments, the joint (RSW) is configured to provide an electrical ground to the apparatus (i.e. through the apparatus) or grounding path between the Aluminum alloy and steel body.

In some embodiments, the joint comprises a weld bond. In some embodiments, the weld bond comprises an adhesive between the first and second sheet which is welded (RSW). In some embodiments, the weld bond is configured to provide corrosion protection to the weld. Some non-limiting examples of adhesives include: epoxies, acrylics, and combinations thereof.

In some embodiments, at least one of the first sheet and second sheet comprises a lubricant along a portion thereof. In some embodiments, the lubricant is left over from the sheet processing (e.g. stamping, rolling, forming, etc). Some non-limiting examples of lubricants include: dry film lubricants, water based lubricants, petroleum-based lubricants, and combinations thereof. In some embodiments, prior to welding, the sheets having lubricants thereon do not need to be cleaned (i.e. to remove the lubricants) prior to welding or weld bonding.

In some embodiments, the weld comprises a weld button pullout range which is: at least about 3 times the square root of the governing gauge, as measured in accordance with JIS Z3140. In some embodiments, the cross-tension strength of the weld is at least about 0.9 kN, as measured in accordance with JIS Z3138. In some embodiments, the tensile strength of the weld is at least about 4.45 kN when measured in accordance with JIS Z3138.

In some embodiments, the first sheet comprises: a wrought material, a cast material, or combinations thereof. In some embodiments, the second sheet comprises: a wrought material, a cast material, or combinations thereof.

In some embodiments, the electrode inserts comprise an electrical conductivity of: not greater than about 80% IACS.

In some embodiments, the first material/first sheet comprises at least one of: a thermal conductivity and an electrical conductivity that is at least 10% lower than that of the second material.

In some embodiments, the second material is selected from the group consisting of: a titanium material (titanium metal or titanium alloy), magnesium material (magnesium metal or magnesium alloy), a steel material (steel alloy), and a copper material (copper metal or copper alloy).

In one aspect of the instant disclosure, a method is provided, comprising: overlapping at least one first sheet of a first material with at least one second sheet of a second material, wherein the first material is different than the second material, further wherein the first sheet comprises a thickness ratio of at least 1.5 the thickness of the second sheet; contacting a pair of electrodes to opposing faces of the first sheet and second sheet to define a weld zone, wherein at least one of the electrodes comprises an electrode insert having an electrical conductivity of not greater than about 54% IACS; welding the first sheet to the second sheet across the weld zone to provide at least one resistance spot weld to join the first sheet to the second sheet.

In one aspect of the instant disclosure, a method is provided, comprising: overlapping at least one first sheet of an aluminum alloy with at least one second sheet of a second material, wherein the second material is selected from the group consisting of: steel; steel alloys; magnesium; magnesium alloys; titanium; titanium alloys; and combinations thereof, wherein the first sheet is at least about 1.5 times thicker than the thickness of the second sheet, wherein the first material comprises at least 10% lower of at least one of: an electrical conductivity and a thermal conductivity, than the second material; contacting a pair of electrodes to opposing faces of the first sheet and second sheet to define a weld zone, wherein at least one of the electrodes comprises an electrode insert having an electrical conductivity of not greater than about 54% IACS; heating a zone across a portion of the first sheet and a portion of the second sheet; and distributing intermetallics throughout the zone to join the first sheet and the second sheet.

In some embodiments, the contacting step further comprises: applying a force to the first sheet and second sheet across the weld zone of at least about 2 kN (e.g. 450 lbs) prior to welding.

In some embodiments, the welding step further comprises: applying a current of at least about 15 kA to the weld zone for a weld time of at least about 60 milliseconds. In some embodiments, the welding step comprises: applying a current of not greater than about 45 kA to the weld zone for a weld time of not greater than about 500 milliseconds.

In some embodiments, the heating step further comprises resistance spot welding the first sheet to the second sheet across the weld zone to provide at least one resistance spot weld to join the first sheet to the second sheet.

In some embodiments, the aluminum sheet is not greater than about 7 mm thick.

In some embodiments, the welding step comprises heating the weld zone to a temperature of at least 750° C.

As used herein, “sheet” means a material that is in the form of a broad, relatively thin piece. In some embodiments, the first sheet and second sheets are of a metal or metal alloy. In some embodiments, the sheet is planar. In some embodiments, the sheet is bent and/or shaped and is non-planar.

In some embodiments, the first sheet comprises aluminum or an aluminum alloy. In some embodiments, any class of aluminum alloy (e.g. Aluminum Association designation) is used with the present apparatuses and methods. Some non-limiting examples of aluminum alloys that employable in one or more embodiments of the instant disclosure include: 1xxx; 2xxx; 3xxx; 5xxx; 6xxx; 7xxx, or combinations thereof. In some non-limiting examples, alloys including Aluminum Association designation 5182; 5754; 6013; 6022; 7055; and 7075 are used.

In some embodiments, the second sheet comprises at least one of: steel, stainless steel, magnesium, copper, or titanium. In some embodiments, the first or second sheet is a monolithic aluminum alloy. In some embodiments, the aluminum alloy is a plurality of layers (e.g. of different alloys), including as non-limiting examples, Al—Si or Al—Si—Zn alloys. In some embodiments, the sheet(s) include clad materials. Some non-limiting examples of clad materials include: 6xxx or 3xxx series aluminum clad with a 4xxx series aluminum alloy (e.g. 4047); 5xxx series aluminum clad with a 1xxx or 7xxx series aluminum; 2xxx series aluminum sheet clad with a 1 xxx, 6xxx, or 7xxx series aluminum. In some embodiments, the alloys include a two-layer aluminum sheet, including, for example two or more different alloys within layers of the sheet. In some embodiments, multiple sheets (i.e. two or more sheets) are joined (e.g. welded) in accordance with one or more embodiments of the instant disclosure.

In some embodiments, the sheets joined in accordance with the apparatuses and/or methods include: aluminum to steel; aluminum to magnesium; aluminum to titanium; aluminum to copper; magnesium to steel; and combinations thereof.

In some embodiments, each sheet (first sheet or second sheet) is: not greater than about 5 mm; not greater than about 4.5 mm; not greater than about 4mm; not greater than about 3.5 mm; not greater than about 3 mm; not greater than about 2.5 mm; not greater than about 2 mm; not greater than about 1.5 mm; not greater than about 1 mm; not greater than about 0.5 mm; or not greater than about 0.1 mm.

In some embodiments, the sheet (first or second sheet) is: at least about 5 mm; at least about 4.5 mm; at least about 4mm; at least about 3.5 mm; at least about 3 mm; at least about 2.5 mm; at least about 2 mm; at least about 1.5 mm; at least about 1 mm; at least about 0.5 mm; or at least about 0.1 mm. In some embodiments, the first sheet is from about 1 mm to about 3.5 mm. In some embodiments, the second sheet is about 0.6 mm to about 1.5 mm.

In some embodiments, the ratio of the thickness of the first sheet to the second sheet is: at least about 1:1; at least about 2:1; at least about 3:1; at least about 4:1; at least about 5:1 or greater. In some embodiments, the ratio of the thickness of the first sheet to the second sheet is: not greater than about 1:1; not greater than about 2:1; not greater than about 3:1; not greater than about 4:1; not greater than about 5:1, or greater. In some embodiments, the first sheet (e.g. aluminum sheet) has a gauge that is between about 1 to 3 times the thickness of the steel sheet. In some embodiments, the aluminum sheet's gauge ranges about 1.5 to 2.5 times the thickness of the steel sheet. In some embodiments, the apparatus comprises an auto structure (e.g. body structures and/or closure panels). In some embodiments, the apparatus comprises a closure panel.

In some embodiments, the ratio of the thickness of the second sheet to the first sheet is: at least about 1:1; at least about 2:1; at least about 3:1; at least about 4:1; at least about 5:1; at least about 6:1, or greater. In some embodiments, the ratio of the thickness of the second sheet to the first sheet is: not greater than about 1:1; not greater than about 2:1; not greater than about 3:1; not greater than about 4:1; not greater than about 5:1, not greater than about 6:1; or less. In some embodiments, the second sheet (e.g. non-aluminum sheet) has a gauge that is at between about 1 to 3 times the thickness of the first sheet (e.g. aluminum sheet). In some embodiments, the steel sheet's gauge ranges about 1.5 to 2.5 times the thickness of the aluminum sheet.

Electric conductivity, as used herein, refers to a materials ability to conduct electricity. In some embodiments, the first sheet comprises an electrical conductivity that is at least about 10% lower than an electrical conductivity of the second sheet. The Table below details the ratios of electrical conductivity and thermal conductivity of various examples of materials, as compared to aluminum. As depicted in the Table, the electrical conductivity of aluminum is higher than the other metals. In some embodiments, the conductivity of aluminum is 4 to 5× higher than the steel alloys and when compared to stainless and titanium, the conductivity difference between aluminum and these materials is even greater (e.g. ˜20 to 40×.). Without being bound to a particular mechanism or theory, it is thought that the resistive heat is inversely proportional to the electrical conductivity; hence, there is a mismatch in heat generated for a given current when joining aluminum to the aforementioned materials. In some embodiments, the methods of the instant disclosure generate the appropriate heat balance to join materials without causing excessive melting and/or electrode penetration in the aluminum. In some embodiments, the electrical conductivity of the first sheet is at least about three times higher than the conductivity of the second sheet. In some embodiments, the electrical conductivity of the first sheet is at least about two times higher than the conductivity of the second sheet. In some embodiments, the electrical conductivity of the first sheet is at least about four times higher than the conductivity of the second sheet.

Table 1 displays the approximate ratios of electrical conductivity and thermal conductivity of an average for aluminum alloys (mean value for 1xxx, 3xxx, 4xxx, 5xxx, 6xxx, and 7xxx alloys) compared to non-aluminum metals (e.g. copper, magnesium, steel, stainless steel, and titanium).

TABLE 1

| Approximate Ratios of | | |
|---|---|---|
| Aluminum Alloys to | Electrical | Thermal |
| the Following Metals | Conductivity | Conductivity |
| Copper | 0.4 | 0.4 |
| Magnesium | 2.3 | 1.7 |
| Steel (AISI 1000-9000) | 4.6 | 3.4 |
| Stainless Steel | 18.6 | 10.8 |
| Titanium | 39.0 | 22.7 |

As used herein, thermal conductivity refers to a materials ability to conduct heat. In some embodiments, the first sheet comprises a thermal conductivity that is at least about 10% lower than an electrical conductivity of the second sheet. As set forth above, there is a difference in the thermal conductivities between aluminum and the other exemplary materials in the Table. In general, aluminum has roughly 3 to 4 times the thermal conductivity of steel. In some embodiments, the welding includes using insert electrodes that alter the heat transfer in the weld region (e.g. across the weld zone) to compensate for the differences in thermal conductivity between the metals. In some embodiments, the insert electrodes enable a temperature across the joint sufficient to weld the sheet materials together.

As used herein, “joint” refers to a location where two things are connected.

In some embodiments, the joint includes overlapping portions of the first sheet and the second sheet. In some embodiments, the joint comprises a weld. In some embodiments, the joint comprises a weld bond. In some embodiments, a weld bond is formed from an adhesive between the first and second sheets, which is welded through so that the sheets are joined by the adhesive bond and the weld(s). Some non-limiting examples of adhesives include: epoxies, acrylics, etc. and combinations thereof.

As used herein, “weld” refers to a joint obtained by welding two materials together. In some embodiments, the sheet includes a lubricant along at least a portion thereof. Non-limiting examples of lubricants include: dry film, water based, petroleum based and combinations thereof.

In some embodiments, when testing the resulting weld (joint) the two sheets are pulled apart from one another. If the zone of the joint (weld) pulls the material from the other sheet, this resulting zone is called a button. When quantifying the button (e.g. for measuring weld zones, including failed weld zones/failure mode), the button pullout range is used. As used herein, the button pullout range refers to the diameter of a button or interfacial fracture (e.g. indicative of a failure mode). In some embodiments, the button pull refers to the portion of the opposing sheet that comes out with a peel test (where the pullout range quantifies the size.). In some embodiments, the button pullout range comprises standardized requirements (e.g. in the American Welding Society (AWS), or the Japanese Industrial Standards (JIS)). In some embodiments, the button pullout range is: at least about 3 times square root of the governing gauge; at least about 4 times the square root of the governing gauge; at least about 5 times the square root of the governing gauge, or at least about 6 times the square root of the governing gauge. In some embodiments, the button pullout range is: not greater than about 3 times square root of the governing gauge; not greater than about 4 times the square root of the governing gauge; not greater than about 5 times the square root of the governing gauge, or not greater than about 6 times the square root of the governing gauge. In some embodiments, the governing gauge is typically the thinnest member in a two (2) layer stackup or the second thinnest member in a three (3) layer stackup.

As used herein, “cross-tension strength” refers to the peel strength of the welded material as measured in a peel loading scenario. In some embodiments, the joint comprises a cross-tension strength of at least about 0.9 kN (i.e. peel strength). In some embodiments, cross tension strengths are between 50% to 75% of the lap shear strength. In some embodiments, for some alloys, the cross tension strengths are lower, in the 25% to 33% range. For this set of experiments, as there is no standard for cross tension strengths, the ratio with the lap shear was compared, as there are standards in both AWS and JIS. In some embodiments, cross tension strengths are approximately 20 to 25% of the lap shear values. In some embodiments, the joints have an adhesive between the metals (e.g. to minimize any corrosion.). Experiments were completed to determine the tensile shear strength so for various aluminum and high strength steel sheets with photos of the tensiles. FIGS. 15-17 depict the photos of the lap shear tensile coupons. FIG. 14 depicts the lap shear performance results. Welding samples for these tests follow specimens in JIS 3138 Method of Fatigue Testing for Spot Welded Joints. As used herein, “tensile strength” refers to the lap sheer as measured across the welded material. In some embodiments, the joint comprises a tensile strength of at least about 4.45 kN.

In some embodiments, the joint comprises a tensile strength of: at least about 4.5 kN; at least about 5 kN; at least about 5.5 kN; at least about 6 kN; at least about 6.5 kN; at least about 7 kN; at least about 7.5 kN; at least about 8 kN; at least about 8.5 kN; at least about 9 kN; at least about 9.5 kN; or at least about 10 kN.

In some embodiments, the joint comprises a tensile strength of: not greater than about 4.5 kN; not greater than about 5 kN; not greater than about 5.5 kN; not greater than about 6 kN; not greater than about 6.5 kN; not greater than about 7 kN; not greater than about 7.5 kN; not greater than about 8 kN; not greater than about 8.5 kN; not greater than about 9 kN; not greater than about 9.5 kN; or not greater than about 10 kN.

In some embodiments, the lap shear tensile strength will be dependent upon the sheet gauges and alloys being welded. Additionally within a region, the lap shear tensile strength will increase with the sheet gauge. The range for aluminum to aluminum welds are specified in Table 1 of the AWS D17.2. The completed testing has shown that in accordance with the various embodiments of the instant disclosure, the strength of aluminum to steel joints reach at least 80% of the strengths specified in AWS D17.2 for aluminum to aluminum.

In some embodiments, at least one of the first sheet and second sheet comprise a wrought material, cast material, or combinations thereof.

In another aspect of the instant disclosure, a method is provided. The method comprises: aligning a first sheet of an aluminum alloy with a second sheet of a second non-aluminum material, wherein the first sheet comprises at least a factor of 1.5 thicker than the second sheet; and welding the aluminum sheet to the first sheet to the second sheet.

As used herein, aligning refers to: bringing two or more materials into line or alignment. In some embodiments, the aligning step includes aligning the first sheet with the second sheet such that a resistance spot welding can be performed on the sheet. In some embodiments, the aligning step comprises: overlapping the first sheet with the second sheet to provide an overlap region (i.e. to be welded, or bond welded).

In some embodiments, welding comprises resistance spot welding. In some embodiments, welding comprises heating and distributing the intermetallics of the first and second sheet throughout the weld zone (e.g. uniformly distributing).

In some embodiments, the welding step is completed with electrode inserts. In some embodiments, the electrode insert comprises a smooth surface. In some embodiments, the electrode insert comprises a grooved surface. In some embodiments, the electrode insert comprises a concentric pattern along the surface. In some embodiments, the electrode inserts comprise a surface roughening.

In some embodiments, the electrode inserts comprise an electrical conductivity of: not greater than about 80% IACS; not greater than about 70% IACS; not greater than about 60% IACS; not greater than about 54% IACS; not greater than about 50% IACS; not greater than about 40% IACS; or not greater than about 30% IACs. In some embodiments, the electrode inserts comprise an electrical conductivity of: at least about 80% IACS; at least about 70% IACS; at least about 60% IACS; at least about 54% IACS; at least about 50% IACS; at least about 40% IACS; or at least about 30% IACS.

In some embodiments, the welding step comprises bringing the weld zone to temperatures of: a state which is sufficient to join the materials (i.e. a temperature which surpasses the liquidus temperature of at least one (or both) of the materials to bring it to a molten state. In some embodiments, the weld temperature is: at least about 750° C.; at least about 800° C.; at least about 850° C.; at least about 900° C.; at least about 950° C.; at least about 1000° C.; at least about 1100° C.; at least about 1200° C.; at least about 1300° C.; at least about 1400° C.; at least about 1500° C.; or higher. In some embodiments, the welding step comprises bringing the weld zone to temperatures of: not greater than about 750° C.; not greater than about 800° C.; not greater than about 850° C.; not greater than about 900° C.; not greater than about 950° C.; not greater than about 1000° C.; not greater than about 1100° C.; not greater than about 1200° C.; not greater than about 1300° C.; not greater than about 1400° C.; not greater than about 1500° C.; or higher. In some embodiments, welding temperatures are approximated through computer modeling (e.g. Finite element analysis or FEA).

As used herein, “weld current” refers to the amount of current that is passed from one electrode to another, through the weld zone to complete the weld.

In some embodiments, welding (resistance spot welding) with the electrodes (i.e. having at least one electrode insert with an electrical conductivity of not greater than 80% IACs) is done with a weld current of: at least about 15 kA; at least about 20 kA; at least about 25 kA; at least about 30 kA; at least about 35 kA; at least about 40 kA; at least about 45 kA; or at least about 50 kA. In some embodiments, welding (resistance spot welding) with the electrodes (i.e. having at least one electrode inert with an electrical conductivity of not greater than 80% IACs) is done with a weld current of: not greater than about 15 kA; not greater than about 20 kA; not greater than about 25 kA; not greater than about 30 kA; not greater than about 35 kA; not greater than about 40 kA; not greater than about 45 kA; or not greater than about 50 kA.

As used herein, “weld time” refers to the amount of time that the weld current is flowing through the weld zone, from one electrode to another.

In some embodiments, the weld time for completing a resistance spot weld with at least one electrode insert in accordance with the instant disclosure is: at least about 50 milliseconds; at least about 60 milliseconds; at least about 100 milliseconds; at least about 150 milliseconds; at least about 200 milliseconds; at least about 250 milliseconds; at least about 300 milliseconds; at least about 350 milliseconds; at least about 400 milliseconds; at least about 450 milliseconds; at least about 500 milliseconds; at least about 550 milliseconds; at least about 600 milliseconds; at least about 650 milliseconds; at least about 700 milliseconds; at least about 750 milliseconds; or at least about 800 milliseconds.

In some embodiments, the weld time for completing a resistance spot weld with at least one electrode insert in accordance with the instant disclosure is: not greater than about 50 milliseconds; not greater than about 60 milliseconds; not greater than about 100 milliseconds; not greater than about 150 milliseconds; not greater than about 200 milliseconds; not greater than about 250 milliseconds; not greater than about 300 milliseconds; not greater than about 350 milliseconds; not greater than about 400 milliseconds; not greater than about 450 milliseconds; not greater than about 500 milliseconds, not greater than about 550 milliseconds; not greater than about 600 milliseconds; not greater than about 650 milliseconds; not greater than about 700 milliseconds; not greater than about 750 milliseconds; or not greater than about 800 milliseconds. In some embodiments, one or more of the electrode orientations, geometries, or dimensions are interchangeable to balance the heat appropriately between various stack up ratios, alloy combinations, and power supply polarity effects.

In some embodiments, one electrode insert having the aforementioned IACS is used to weld (e.g. RSW) the materials in conjunction with another electrode having an electrode insert (or no insert) with an IACS outside the range specified (i.e. outside of the range of 30% IACS to 80% IACS). In some embodiments, a pair of electrodes are used where the electrode inserts have the same IACS. In some embodiments, a pair of electrodes are used to weld the at least two sheets together, where the electrode inserts have a different % IACs (e.g. within the range of 30% to 80%).

In some embodiments, the insert thickness of: at least about 4 mm; at least about 6 mm; at least about 8 mm; at least about 10 mm; or at least about 12 mm. In some embodiments, the insert comprises a thickness of: not greater than about 4 mm; not greater than about 6 mm; not greater than about 8 mm; not greater than about 10 mm; or not greater than about 12 mm.

In some embodiments, the insert diameter is greater than, the same as, or smaller than, the material body stock (e.g. the electrode body). In some embodiments, the insert is connected to the body of the electrode with a brazed connection. In some embodiments, the insert is connected to the body of the electrode by a mechanical attachment. In some embodiments, the inserts are attached by a variety of methods which include, but are not limited to: mechanical interlocking, brazing, cold pressure welding, diffusion, hot upset welding, and friction welding.

In one or more embodiments of the present methods, the welding employs electrodes having a low conductivity insert. Without being bound to a particular mechanism or theory, the electrodes are employed in the welding step, such that the electrodes alter the temperature profile and temperature distribution across the weld zone, yielding welds that have an increased peel strength and increased tensile strength as compared to welds completed with traditional electrodes on materials with the above-referenced limitations on thickness ratios and surface preparation.

In some embodiments, a variety of insert materials can be employed with the welding step in various geometries and configurations for different gauge stack ups, alloy families, product types, and surface coatings. In some embodiments, the welding step is completed on sheets that include a variety of lubricants and/or adhesives (e.g. weld bonding), e.g. to aid in corrosion resistance and corrosion reduction.

In some embodiments, the welding step comprises creating a weld comprising a cross-tension strength of at least about 0.91 kN (peel strength). In some embodiments, the cross-tension strength of the weld is: at least about 1 kN; at least about 1.5 kN; at least about 2 kN; at least about 2.5 kN; at least about 3 kN; at least about 3.5 kN; at least about 4 kN; at least about 4.5 kN; at least about 5 kN; at least about 5.5 kN; at least about 6 kN; at least about 6.5 kN; or at least about 7 kN.

In some embodiments, the cross-tension strength of the weld is: not greater than about 1 kN; not greater than about 1.5 kN; not greater than about 2 kN; not greater than about 2.5 kN; not greater than about 3 kN; not greater than about 3.5 kN; not greater than about 4 kN; not greater than about 4.5 kN; not greater than about 5 kN; not greater than about 5.5 kN; not greater than about 6 kN; not greater than about 6.5 kN; or not greater than about 7 kN.

In some embodiments, the welding step comprises providing a weld comprising a tensile strength of at least about 4.45 kN.

In some embodiments, the tensile strength of the weld is: at least about 2 kN; at least about 3 kN; at least about 3.5 kN; at least about 4 kN; 4.5 kN; at least about 5 kN; at least about 5.5 kN; at least about 6 kN; at least about 6.5 kN; at least about 7 kN; at least about 7.5 kN; at least about 8 kN; at least about 8.5 kN; at least about 9 kN; at least about 9.5 kN; at least about 10 kN; at least about 10.5 kN; at least about 11 kN; at least about 11.5 kN; at least about 12 kN; at least about 12.5 kN; at least about 13 kN; at least about 13.5 kN; or at least about 14 kN.

In some embodiments, the tensile strength of the weld is: not greater than about 2 kN; not greater than about 2.5 kN; not greater than about 3 kN; not greater than about 3.5 kN; not greater than about 4 kN; not greater than about 4.5 kN; not greater than about 5 kN; not greater than about 5.5 kN; not greater than about 6 kN; not greater than about 6.5 kN; not greater than about 7 kN; not greater than about 7.5 kN; not greater than about 8 kN; not greater than about 8.5 kN; not greater than about 9 kN; not greater than about 9.5 kN; not greater than about 10 kN; not greater than about 10.5 kN; not greater than about 11 kN; not greater than about 11.5 kN; not greater than about 12 kN; not greater than about 12.5 kN; not greater than about 13 kN; not greater than about 13.5 kN; or not greater than about 14 kN.

In some embodiments the welding step comprises providing a weld comprising a tensile strength of at least 80% of the minimum specified for the aluminum sheet per AWS D17.2.

In some embodiments, the tensile strength of the weld is: at least about 80%; at least about 90%; at least about 100%; at least about 125%; at least about 150%; at least about 175%; or at least about 200% of the minimum specified for aluminum sheet per AWS D17.2. The American welding society D17.2 is the specification for resistance welding for aerospace applications.

In some embodiments, the tensile strength of the weld is: not greater than about 80%; not greater than about 90%; not greater than about 100%; not greater than about 125%; not greater than about 150%; not greater than about 175%; or not greater than about 200% of the minimum specified for aluminum sheet per AWS D17.2;

Reference will now be made in detail to the accompanying drawings, which at least assist in illustrating various pertinent embodiments of the present invention.

### BRIEF DESCRIPTION OF THE DRAWINGS

FIGS. 1A and 1B provide an illustrative example of sheet ratios (steel to aluminum) and the resulting weld buttons pursuant to experiments performed in the detailed description below.

FIG. 2 depicts the material temperatures at the end of the weld pulse for an aluminum sheet (1 mm thick) to a steel sheet (0.5 mm thick), using 6.5 mm CuCr Electrodes, 18 kA DC, 300 msec Weld Time, 1.8 kN Force.

FIG. 3 depicts the material temperatures at the end of the weld pulse for aluminum sheet (1 mm thick) to steel sheet (0.5 mm thick) using a 100 mm R CuCr Electrode, 24 kA DC, 200 msec Weld Time, 4 kN Force, St/Al Thickness Ratio=0.5.

FIG. 4 depicts the material temperatures at the end of the weld pulse for an aluminum sheet (1 mm thick) to steel sheets (4 layers, at 0.5 mm thickness per sheet) using a 100 mm R CuCr Electrode, 24 kA DC, 200 ms Time, 4 kN Force, St/Al Thickness Ratio=2.0.

FIG. 5 depicts the material temperatures at the end of the weld pulse for aluminum sheet (1 mm thick) to steel sheets (6 layers, at 0.5 mm thickness per sheet) using a 100 mm R CuCr Electrode, 24 kA DC, 200 ms Time, 4 kN Force, St/Al Thickness Ratio=3.0.

FIG. 6 is a chart depicting the peak temperature (maximum welding temperature in degrees C.) in aluminum sheet plotted by time (milliseconds), for six different thickness ratios of aluminum to steel, where the welds were completed with a 100 mm R CuCr Elect, 24 kA DC, 200 ms Time, 4 kN Force, various St/Al Stack up Ratios. (Note—2×0.5 mm St denotes two sheets of 0.5 mm Steel).

FIG. 7 depicts various examples of a conventional electrode (A) and insert electrodes (B-D) used in RSW of aluminum and steels in accordance with the instant disclosure.

FIG. 8 depicts additional examples insert electrodes for various electrode geometries used in RSW of aluminum and steels in accordance with the instant disclosure.

FIGS. 9A and 9B depict a computer simulation of two embodiments of insert electrode geometries, modeled as RSW dissimilar materials (aluminum and steel). The lines depict the pressure and electrical gradients.

FIG. 10 is a plot of the peak temperature in aluminum sheet (measured in C) over time (milliseconds) for four types of electrode combinations (no insert, bottom insert, top insert, and both insert), for a weld of 1 mm thick Aluminum to 0.5 mm thick Steel using a 100 mm R CuCr Electrode and 100 mm R Insert Electrode Conditions, 24 kA DC, 200 ms Time, 4 kN Force, St/Al Ratio=0.5.

FIG. 11 is a plot of the peak temperature in aluminum sheet (measured in C) over time (milliseconds) for four types of electrode combinations, for a weld of 3 mm thick aluminum to 0.75 mm thick steel, using a 100 mm R CuCr Elect and 100 mm R Insert Electrode Conditions, 24 kA DC, 200 ms Time, 4 kN Force, St/Al Ratio=0.25.

FIG. 12 is a photograph of insert electrodes employed in differential heat balancing welding; where the electrodes comprise a 16 mm body diameter, with the insert material brazed to standard electrode material backer.

FIG. 13 is a photograph depicting the peel testing results of dissimilar RSW joints between aluminum and steel, formed by RSW with insert electrodes. The top sheet is aluminum, while the lower sheet is steel, with the peeled weld buttons depicted along each sheet. The numbers along the top depict the measured values for the diameter of the peeled nugget (weld pull-out). Along the opposing sheet the tear out portion is depicted.

FIG. 14 is a chart displaying the lap shear tensile strengths for weld combinations between combinations of 2 mm 6022-T4 and 6013-T4 welded to 0.7 mm 270 MPa, 0.9 mm 980 MPa, and 1.2 mm 590 MPa galvanized steels.

FIG. 15 is a photograph depicting the lap shear tensile coupons for 2 mm 6022-T4 resistance spot welded to 1.2 mm 590 MPa galvanized steel.

FIG. 16 is a photograph depicting the lap shear tensile coupons for 2 mm 6022-T4 resistance spot welded to 0.7 mm 270 MPa galvanized steel.

FIG. 17 is a photograph depicting the lap shear tensile coupons for 2 mm 6022-T4 resistance spot welded to 0.9 mm 98 MPa galvanized steel.

FIG. 18 is a plot of the peak temperature in aluminum sheet (measured in C) over time (milliseconds) for four types of electrode combinations (no insert, bottom insert, top insert, and both insert), for a weld of 3 mm thick Aluminum to 0.5 mm thick Steel using a 100 mm R CuCr Electrode and 100 mm R Insert Electrode Conditions, 24 kA DC, 200 ms Time, 4 kN Force, St/Al Ratio =0.17.

FIG. 19 is a plot of the peak temperature in aluminum sheet (measured in C) over time (milliseconds) for four types of electrode combinations (no insert, bottom insert, top insert, and both insert), for a weld of 1 mm thick Aluminum to 2 mm thick Steel using a 100 mm R CuCr Electrode and 100 mm R Insert Electrode Conditions, 24 kA DC, 200 ms Time, 4 kN Force, St/Al Ratio=2.

FIG. 20 depicts is a plot of the peak temperature in aluminum sheet (measured in C) over time (milliseconds) for four types of electrodes (no insert, bottom insert, top insert, and both insert), for a weld of 1 mm thick Aluminum to 1 mm thick Steel using a 100 mm R CuCr Electrode and 100 mm R Insert Electrode Conditions, 24 kA DC, 200 ms Time, 4 kN Force, St/Al Ratio=1.

FIG. 21A through 21E depicts a cross-sectional view of resistance spot welds across various T3 samples, depicting the weld zone across different orientations of the first sheet material and second sheet materials.

These and other aspects, advantages, and novel features of the invention are set forth in part in the description that follows and will become apparent to those skilled in the art upon examination of the following description and figures, or may be learned by practicing the invention.

### DETAILED DESCRIPTION

In accordance with one or more embodiments of the instant disclosure, methods for forming a joint between a non-aluminum (e.g. steel) sheet and an aluminum sheet are provided. In some embodiments, the aluminum sheet is greater than or equal to the thickness of the steel sheet. In some embodiments, the joint (e.g. weld) is made without any coating; brazing, or galvanization of the underlying sheets. In some embodiments, the aluminum alloy comprises: a monolithic aluminum alloy; a multi-alloy aluminum sheet (brazing sheet or clad sheet); or a surface coated or plated aluminum alloy sheet (e.g. galvanized sheet). As a non-limiting example.

In some embodiments, the joint (e.g. weld) is completed with a first sheet including: a brazed sheet (e.g. aluminum or monolithic aluminum), brazed alloy clad to it (e.g. 5-15% of thickness), or galvanized underlying sheet (e.g. zinc coating) to a second sheet without any coating; brazing, or galvanization of the underlying sheets. In some embodiments, the weld is a plurality of spot welds (no brazing or brazed materials).

In some embodiments, the cladding on the brazed alloy is: at least about 5% of the thickness of the brazed alloy; at least about 10% of the thickness of the brazed alloy; or at least about 15% of the thickness of the brazed alloy. In some embodiments, the cladding on the brazed alloy is: not greater than about 5% of the thickness of the brazed alloy; not greater than about 10% of the thickness of the brazed alloy; or not greater than about 15% of the thickness of the brazed alloy.

In some embodiments, the welding process includes electrodes which are adapted to provide a differential heating technique across the weld interface/weld zone (e.g. to alter the heat balance during the welding process). In some embodiments, the electrode inserts of the electrodes are configured to provide a differential heating across the sheets to appropriately join the sheets (e.g. via RSW).

In some embodiments, intermetallics that are generated in the weld zone are distributed (e.g. uniformly distributed) across the joint interface, thus, increasing the overall joint strength. In some embodiments, the instant disclosure provides for joining of aluminum strips to steel strips, where the aluminum strips are thicker than the opposing steel strips. In some embodiments, such joining is completed without excessive electrode penetration.

In some embodiments, welding is completed with conventional state-of-the art RSW equipment comprising AC or DC power supplies, pedestal or gun welders. In some embodiments, in lieu of conventional high-conductivity copper or copper-alloy electrodes (RWMA Class 1, 2 or similar), the welding is completed with electrodes that are comprised of materials that have an electrical conductivity of not greater than about 54% IACS (International Annealed Copper Standard). Without being bound to a particular theory of mechanism, it is believed that the welding electrodes of the instant disclosure apply heat to the weld zone for a sufficient period of time to alter the heat transfer across the zone, resulting in the base metals becoming a liquefied state, such that the welds are a mixture of molten metal from both sheets.

In some embodiments, the welds are formed at welding parameters where the electrodes do not have excessive sticking and alloying with the aluminum strips while providing high temperatures (e.g. at or above the liquidous temperature of the aluminum sheet material, to provide the materials in a molten state) at the weld joint. This is believed to result in a weld that has a dispersion of intermetallics across (throughout) the weld, resulting in a strong weld (e.g. increased peel strength). With one or more embodiments of the present disclosure, aluminum components (e.g. aluminum sheet) are integrated into steel assemblies in a part by part basis.

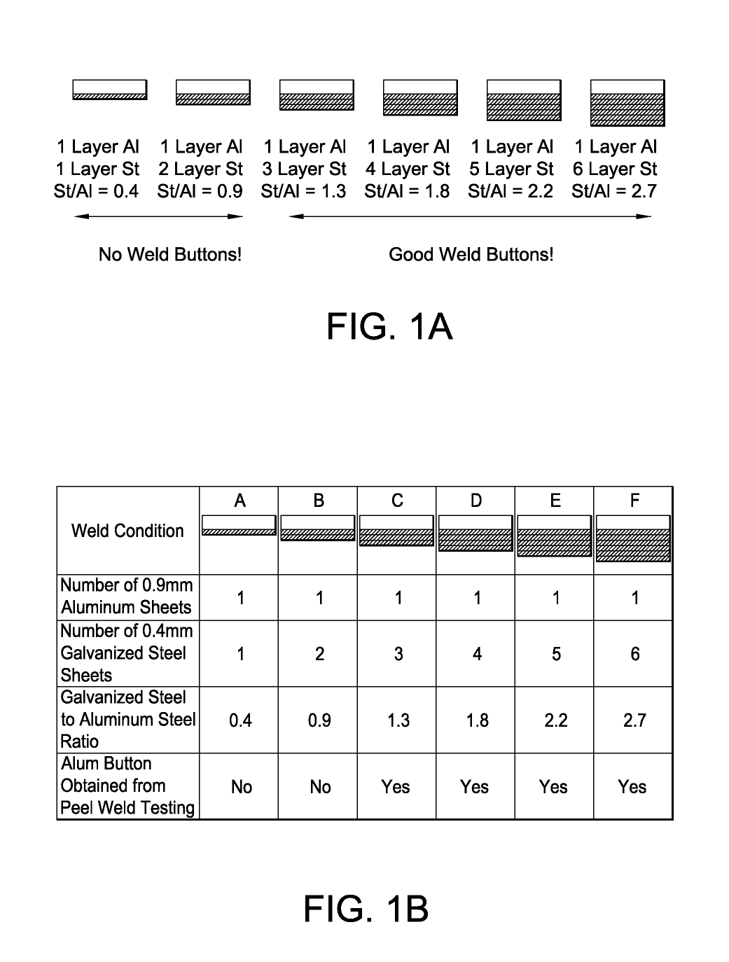

A series of experiments were run on 0.9 mm 6022 aluminum and 0.4 mm galvanized steel. Several trials were conducted such that an additional 0.4 mm gauge was added to the weld stackup as shown in the FIG. 1 below until weld buttons could be obtained in the aluminum member through peel testing. The aluminum is the top strip in the weld stackup (light grey) shown in FIG. 1, while the steel is depicted as the thinner, darker sheets beneath the light sheets. It should be noted that all the welds produced during the experiments shown in FIG. 1 were conducted using conventional RSW equipment, weld parameters, and electrodes.

In some applications the aluminum strip(s) are thicker than the opposing steel strip(s) and this is represented by the two left-most illustrations in FIG. 1. When the ratio of the total thickness of the steel strips to aluminum strip was under 1.0, the weld experiments did not yield a weld button (i.e. a pullout of fused metal), but instead yielded a low-strength, interfacial bond. Thus, the conventional RSW process was unable to generate a weld zone with sufficient strength to produce a button pullout during peel testing. In the experimental conditions, where the steel to aluminum thickness ratio was under 1, the weld button size was 0 (meaning that the weld zone failed interfacially with no opposing material being pulled out). In stack up conditions where the ratio of steel was greater than 1 (four right-most illustrations in FIG. 1), experimental testing yielded button pullouts during peel testing. In general the weld button pullout exceeded and yielded welds of sufficient strength.

A series of computer simulations were completed to model the temperature across the weld zone, and thus, the heat transfer from the electrodes to the sheet materials. Initially, simulations were performed for conventional equipment, electrodes, and materials as a means to develop the baseline conditions. The experimental conditions shown in FIG. 1 were simulated (e.g. in order to validate the model versus the empirical results). Also, simulations were run on the various embodiments of the instant disclosure (e.g. to depict the impact of the electrode conductivity and geometry on weld performance).

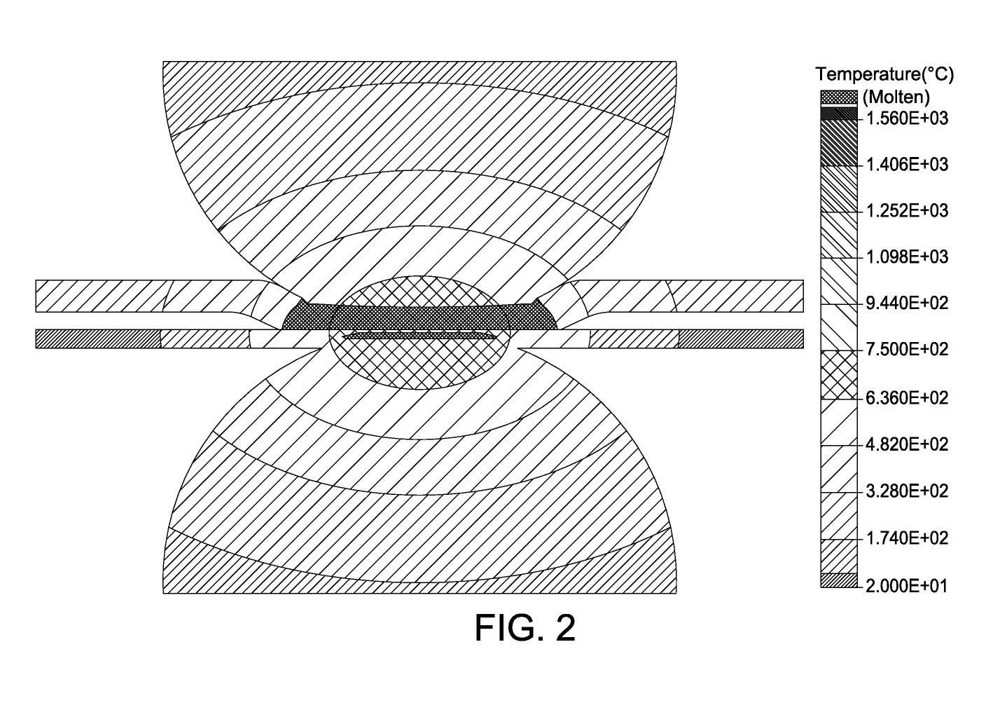

FIG. 2 shows the weld simulation results between 1 mm aluminum and 0.5 mm steel using standard equipment and conventional weld schedules (baseline). Referring to FIG. 2, it is noted that excessive electrode indentation (and subsequent aluminum material thinning) occurs in this configuration. Experimental trials yield similar results and the resultant joint has low peel strength due to the excessive sheet thinning. Thus, this type of weld joint is discrepant and cannot be used for structural welds requiring strength.

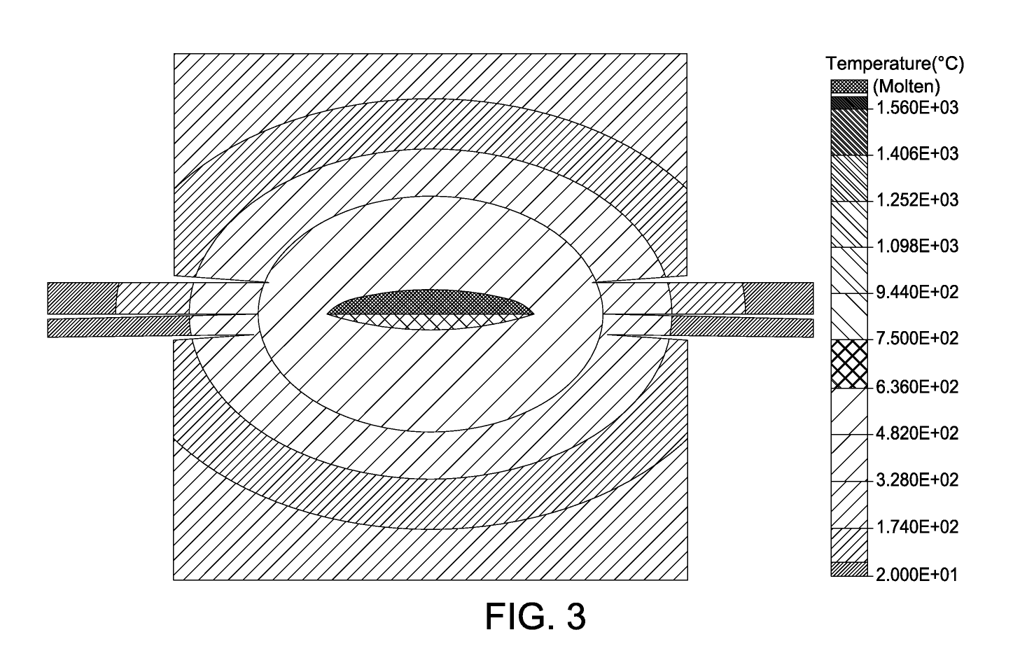

FIG. 3 shows the weld simulation results between 1 mm aluminum and 0.5 mm steel using baseline (conventional) equipment and a modified weld schedule and electrode geometry to reduce the amount of thinning in the aluminum sheet. In comparison to FIG. 2, in FIG. 3, the electrode penetration has been significantly reduced with the new electrode geometry; however, the amount of heat generated in the weld zone is lower than in FIG. 2, such that the temperature is not high enough to enable sufficient fusion between the materials. This simulation would represent the (A) weld condition shown in FIG. 1 and validated the experimental results which yielded interfacial weld fractures.

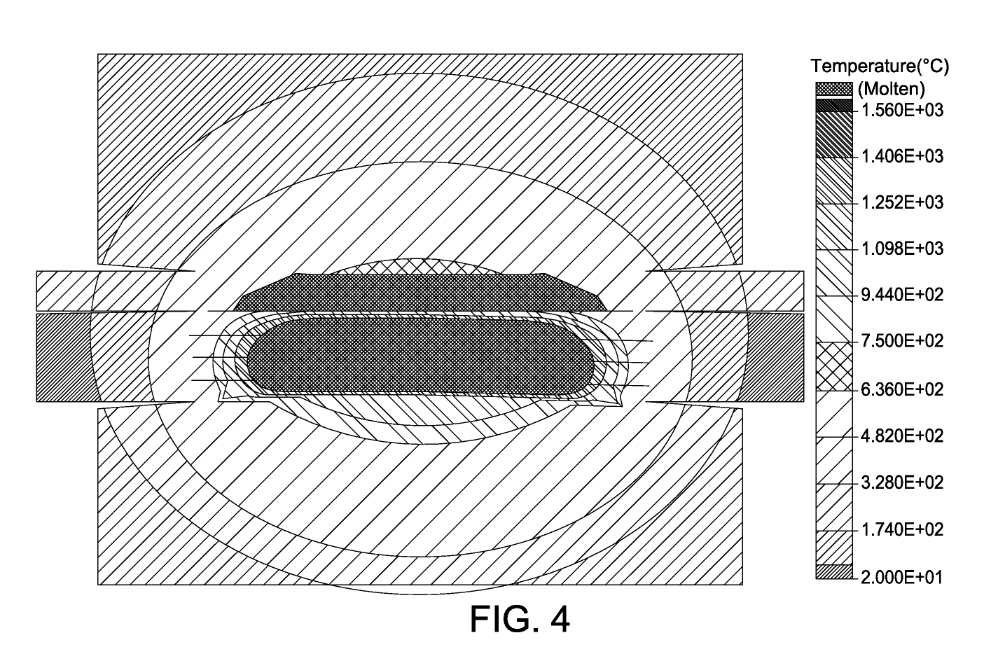

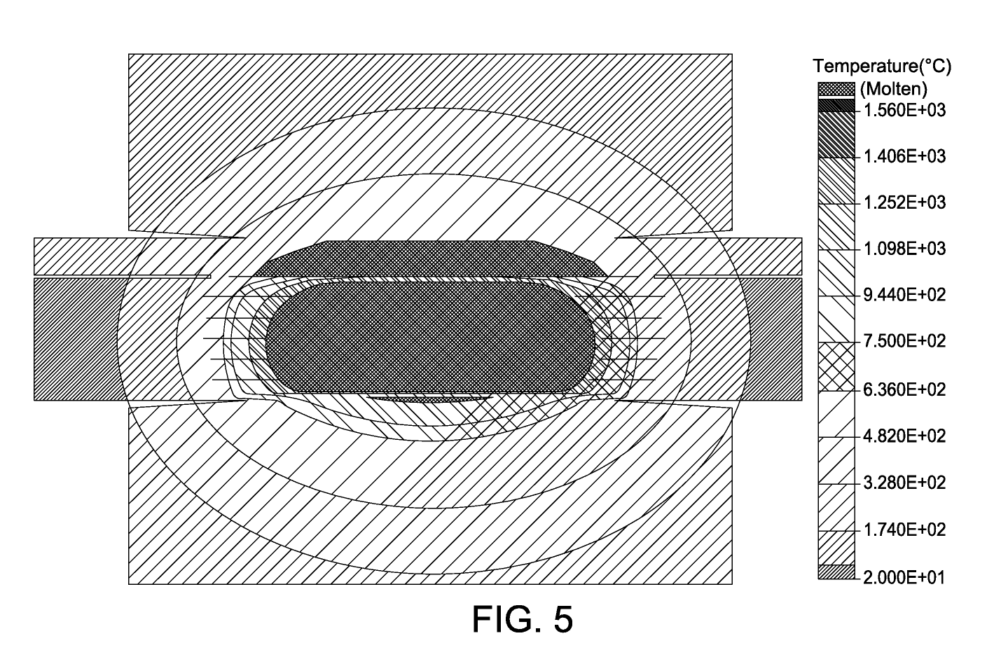

FIGS. 4 and 5 depict the impact of multiple steel sheets on the overall weld development and weld size (e.g. nugget size). Referring to FIGS. 4 and 5, the weld simulation results between 1 mm aluminum and four or six sheets of 0.5 mm steel using the same weld settings as those in FIG. 2 is depicted. This simulation represents the (D-F) illustrations shown in FIG. 1 where the steel to aluminum thickness ratio is around 2 or greater than about 2 (1.8, 2.2, and 2.7, respectively). It was found through simulation that as the steel to aluminum ratio exceeds 1, the joint attains higher temperatures, with greater uniformity than joints with a ratio below 1 (e.g. compare with (A), above).

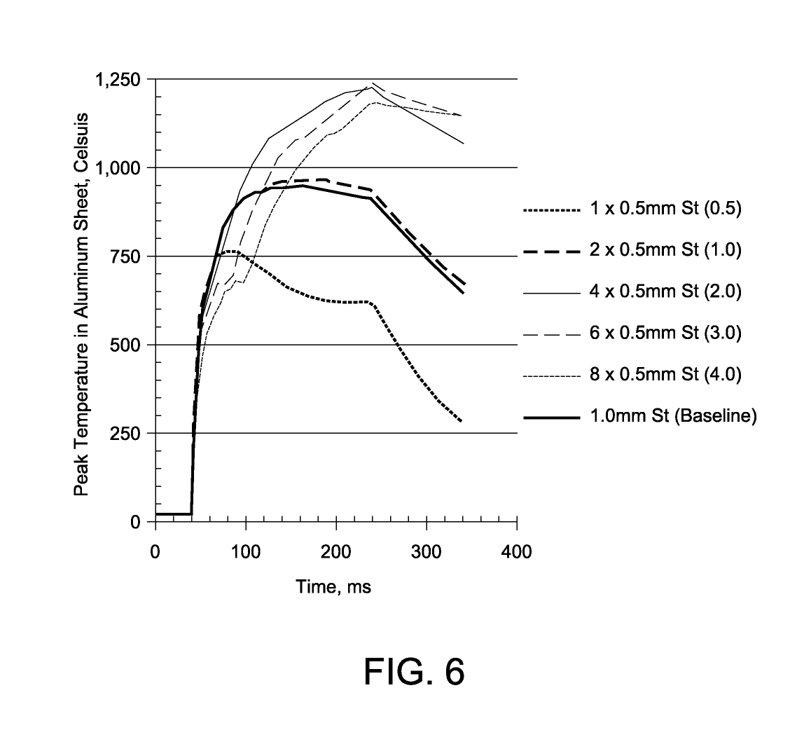

FIG. 6 shows the maximum welding temperatures calculated in the weld simulations of 1 mm aluminum to various number of 0.5 mm steel sheets. Referring to FIG. 6, the maximum temperature observed in the 1 mm aluminum to 0.5 mm steel (St/Al Ratio=0.5) was approximately 750 degrees C. As the steel to aluminum ratio increased above 2 (e.g. 3.0 and 4.0), the maximum temperature exceeded 1100 degrees C., Little electrode penetration was observed in the aluminum sheet/member.

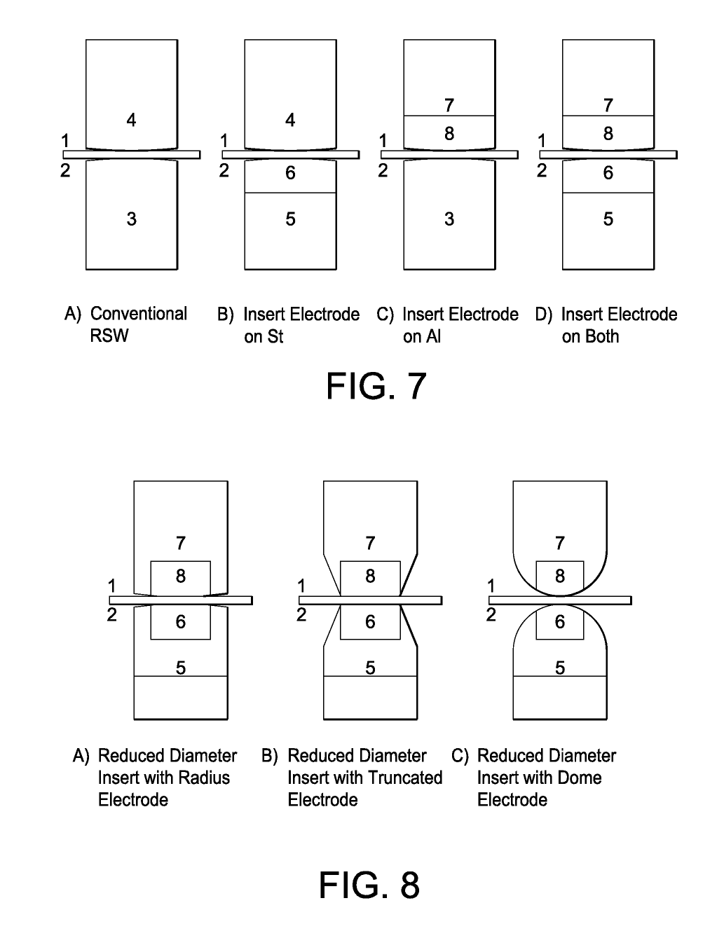

Referring to one or more of the embodiments of the present disclosure, the electrodes used in the present methods to form the present products/apparatuses include electrodes that have a lower conductivity than conventional electrodes used in RSW. In some embodiments, the conductivity of the electrodes is not greater than about 60% IACS (International Annealed Copper Standard). In some non-limiting embodiments, the electrodes include: tungsten-copper alloys, tungsten carbide-copper alloys, molybdenum, tungsten, copper beryllium, copper nickel beryllium, copper nickel silicon beryllium, steel, stainless steel alloys, and combinations thereof. In some embodiments, one or more of the aforementioned materials are formed into inserts for the electrodes, depicted, for example, in FIG. 7 and FIG. 8.

FIG. 7 shows several electrode pairs that can be employed in one or more methods of the instant disclosure. FIG. 7A depicts traditional RWMA (Resistance Welders Manufacturing Association) Class 1 and Class 2 copper alloy electrodes, which typically include electrical conductivities exceeding about 80% IACS. FIGS. 7B through 7D depict some alterative electrode embodiments that are used in one or more embodiments of the present methods. The electrodes of FIGS. 7B-7D include insert electrodes which alter the heat balance of the sheets (e.g. sheet 1 and 2, which are dissimilar). Referring to the various embodiments depicted in FIG. 7, some exemplary configuration of materials is provided, where aluminum is labeled 1; steel is labeled as 2; lower conventional alloy electrode is labeled as 3; upper conventional alloy electrode is labeled as 4; lower insert electrode is labeled as 5 and 6; upper insert electrode is labeled as 7 and 8; and insert materials are labeled as 6 (upper insert material) and 8 (lower insert material).

In various embodiments, the insert electrode is placed against the aluminum, steel, or both materials (i.e. the sheet materials/members) in order to adjust to the material and gauge combinations, further variants are also possible such as having two different insert materials in the condition illustrated in FIG. 7D. In one embodiment, insert 6 is a tungsten-copper while insert 8 is molybdenum. In the aforementioned embodiment, the tungsten-copper (53% IACS) insert is placed against the aluminum member while the molybdenum (30% IACS) insert is placed against the steel member. While illustrative in nature, this example would have a different heat balance than if either insert were employed separately. This flexibility in design is useful in order to reduce electrode wear and sticking of aluminum sheet. FIG. 7 illustrates radiused electrodes with a full-faced insert (disc) other geometries are also applicable.

FIG. 8 illustrates various insert designs which could be employed rather than the brazed electrode construction shown in FIG. 7. A variety of insert materials and geometries were modeled in order to understand the impact of the joint temperature and distribution over time.

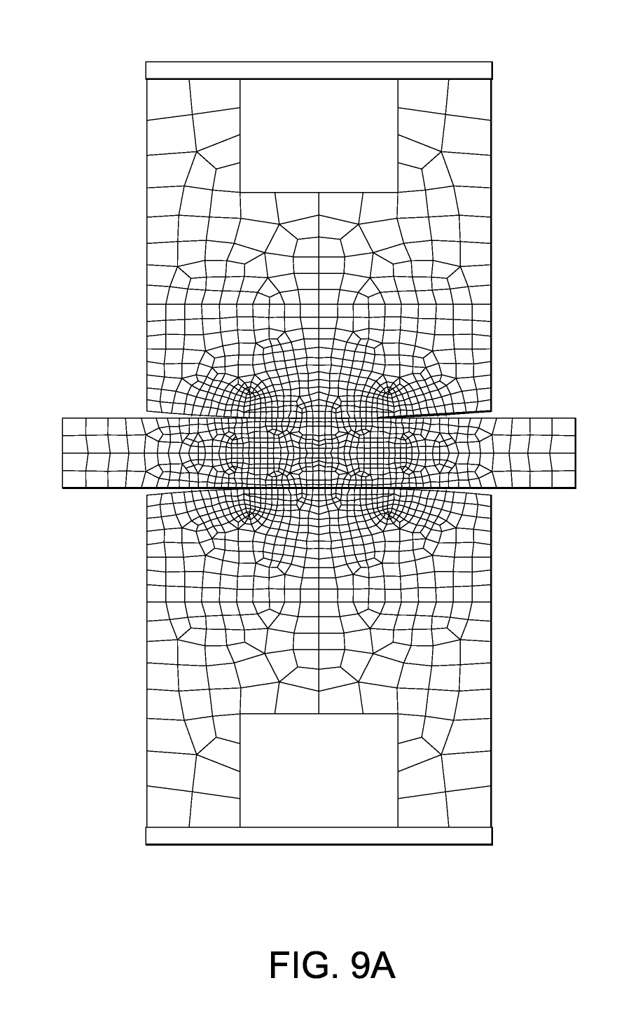

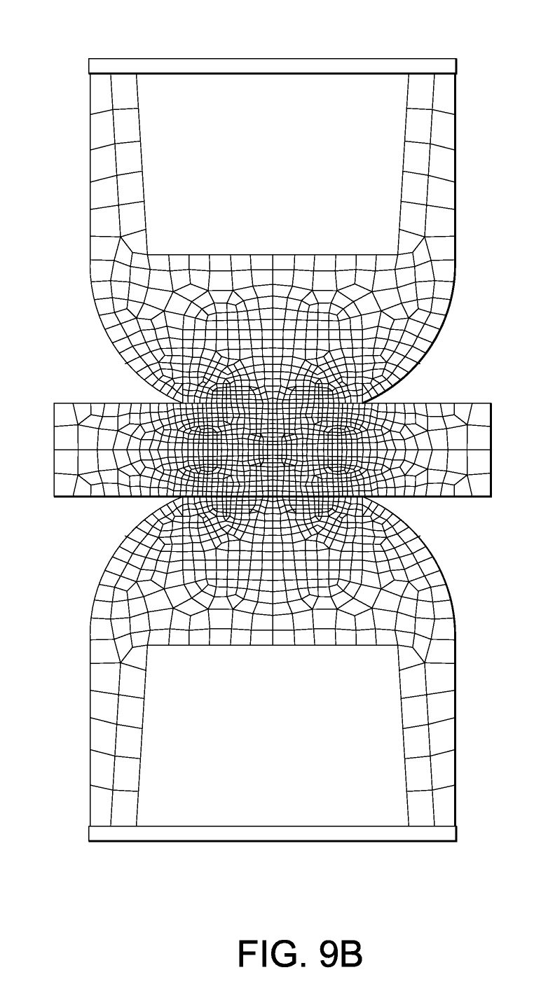

FIG. 9 shows the computer simulations of two such examples of the different variations/embodiments, including: a full faced insert (9A) and a dome electrode insert (9B). The computer simulations depict the weld inserts during weld simulations.

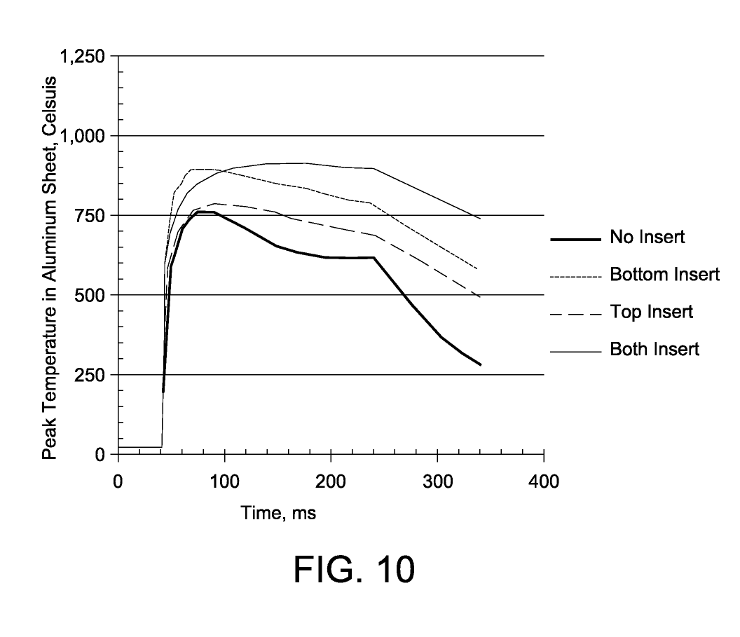

Additionally various aluminum and steel gauge combinations were evaluated for the baseline electrodes (no inserts, standard copper-chromium electrodes) and inserts of the instant disclosure (e.g. top sheet only, bottom sheet only, and both sheets). FIG. 10 depicts a temperature plot for a steel to aluminum stackup ratio of 0.5. Referring to FIG. 10, the three insert configurations increase both the peak and overall temperature across the weld joint as compared to the conventional CuCr or CuCrZr electrodes. In this stack-up condition, all three conditions where insert electrodes were used (top insert, bottom insert, both insert) provided a greater peak temperature than the conventional (non-insert) electrode. As depicted in FIG. 10, the largest contributor to increasing the overall welding temperatures was generated at the bottom insert, or more specifically, the electrode in contact with the steel member.

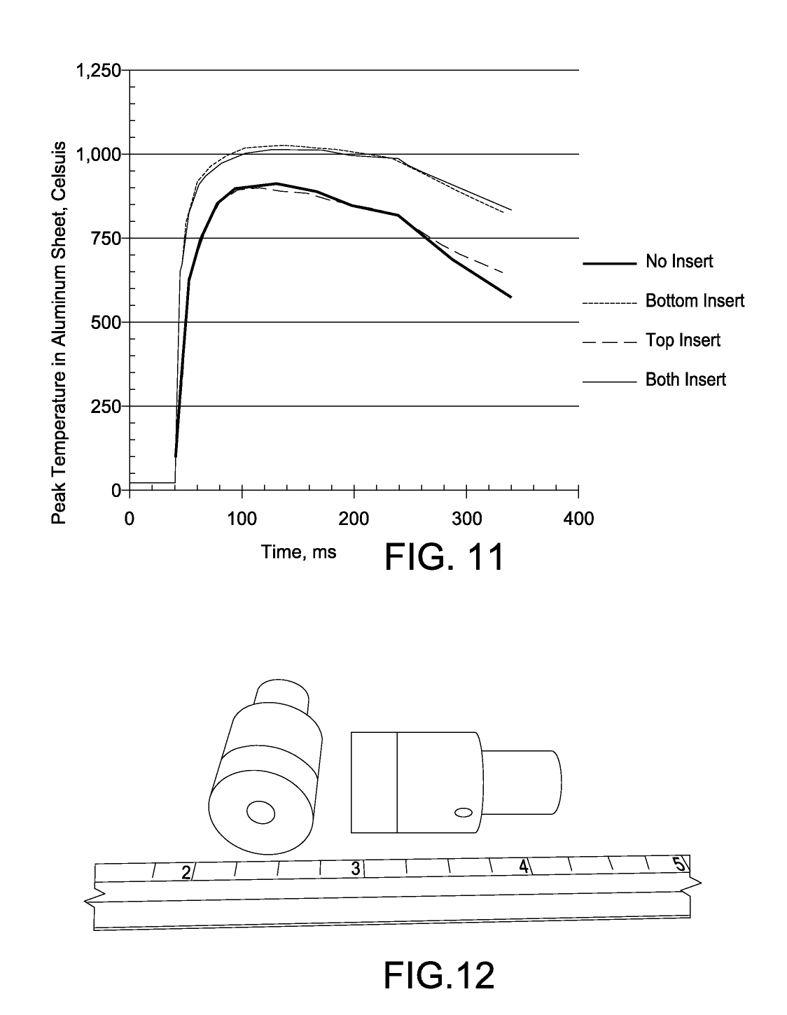

Another example which illustrates the benefit of the insert electrodes of the instant disclosure is depicted in FIG. 11. In this example, the aluminum sheet is 4 times thicker than the steel member, thus the St/Al thickness ratio is equal to 0.25. This simulation follows the trends depicted in FIG. 10. In this stack up condition, the temperature line for the insert electrode on the steel side was greater than when the insert electrode was directly on the aluminum sheet, as the aluminum sheet's gauge was much greater than the steel sheets. Referring to the aforementioned examples regarding the welding simulations and plots of temperature vs. time, the modeling confirms that the insert electrodes used in accordance with one or more of the embodiments of the instant disclosure will alter the temperature in the weld zone such that the weld zone includes dispersed intermetallics across the weld.

For the simulations of FIGS. 10, 11, 18, 19, and 20, all of the simulation runs had the aluminum sheet on top and the steel sheet on the bottom. Referring to the Figures, the insert electrode had its greatest effect when it was against the steel sheet. In both FIGS. 10 and 11, the bottom insert condition is more effective at increasing the peak temperature in the aluminum sheet than the top insert only condition. Additionally, the bottom insert only condition is similar to having inserts on both sides.

In some embodiments, the insert electrode can be effective when it is against the aluminum sheet only. Without being bound to a particular mechanism or theory, the effectiveness of the peak temperature in aluminum is believed to be dependent upon the thickness of the steel sheet. When the steel is relatively thin (i.e. 0.5 mm), the top insert electrode did not increase the overall temperature as compared to the no insert (or standard copper electrode) condition as depicted in FIG. 10. As the thickness of the steel increases (FIG. 11 which as 0.75 mm steel sheet), the top insert is not as effective. Without being bound to a particular mechanism or theory, it is believed that it is not as effect because the steel sheet has a greater impact on the thermal conductivity than the aluminum sheet.

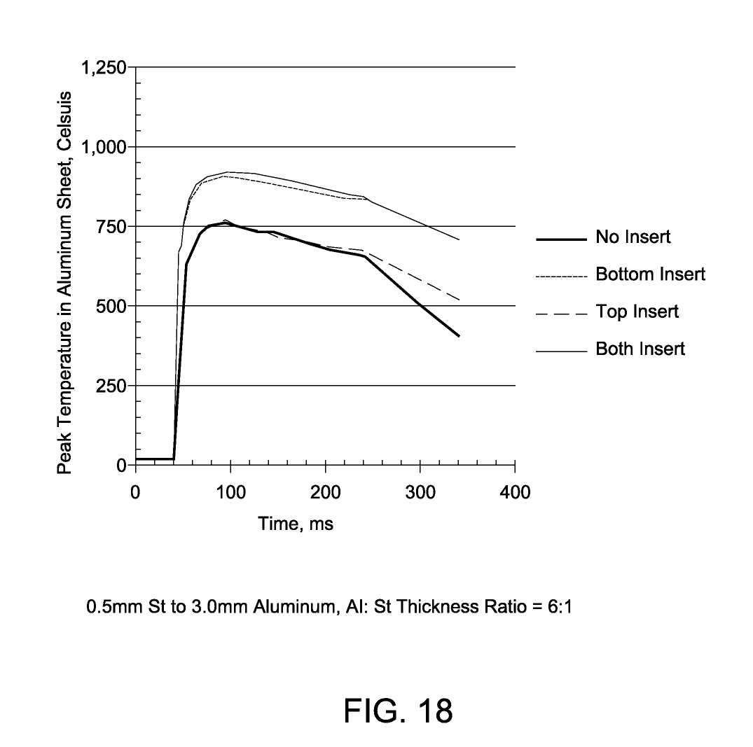

Referring to FIG. 18, a 6:1 ratio of aluminum to steel thicknesses is depicted. The best two performing simulations were when both insert electrodes were used and when a bottom only electrode insert was used. The remaining two simulations (top insert and no insert) performed in a relatively similar fashion, with both peaking around 750 C and dropping down from there as time increased. Thus, without being bound to a particular mechanism or theory, as the aluminum thickness increases, in order to obtain the appropriate heat in the weld zone to achieve a weld, at least one electrode insert is needed along the bottom (or, both electrode inserts can be used).

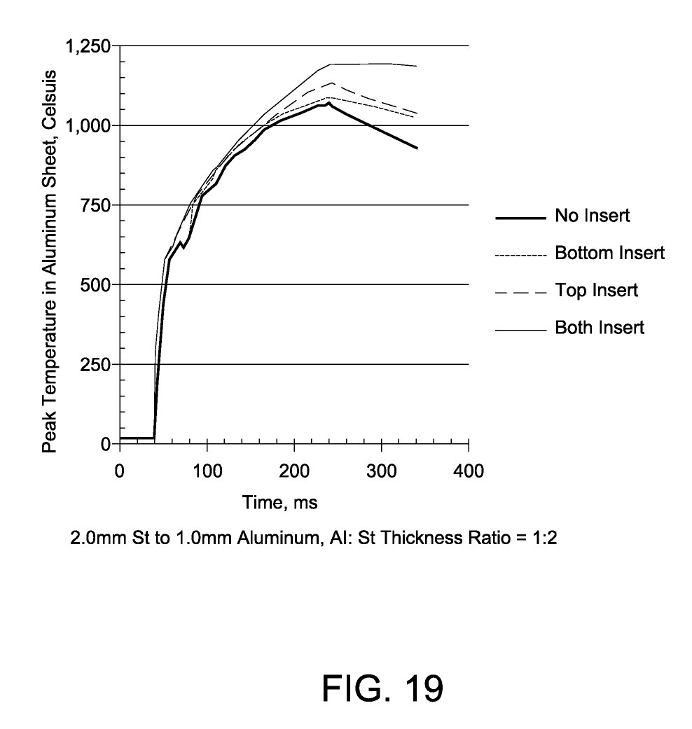

Referring to FIG. 19, a 1:2 ratio of aluminum to steel is depicted. Without being bound to a particular mechanism or theory, as steel has a greater electrical and thermal conductivity than aluminum, all four electrode combinations performed well, with peak temperatures in each instance above 1000 C. Thus, there is no issue with utilizing traditional electrodes (e.g. copper electrodes) when the steel is thicker than the aluminum, as in FIG. 19.

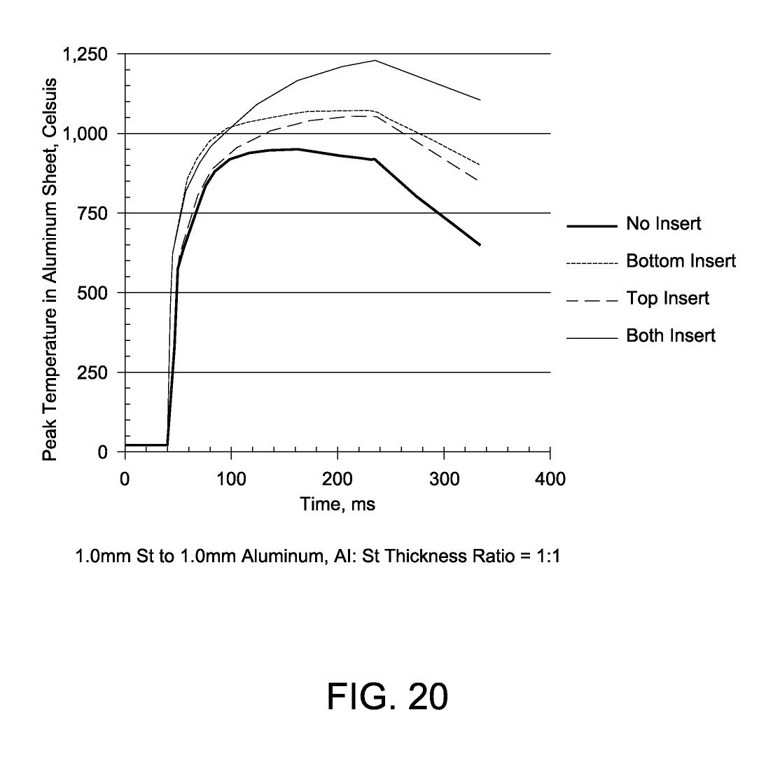

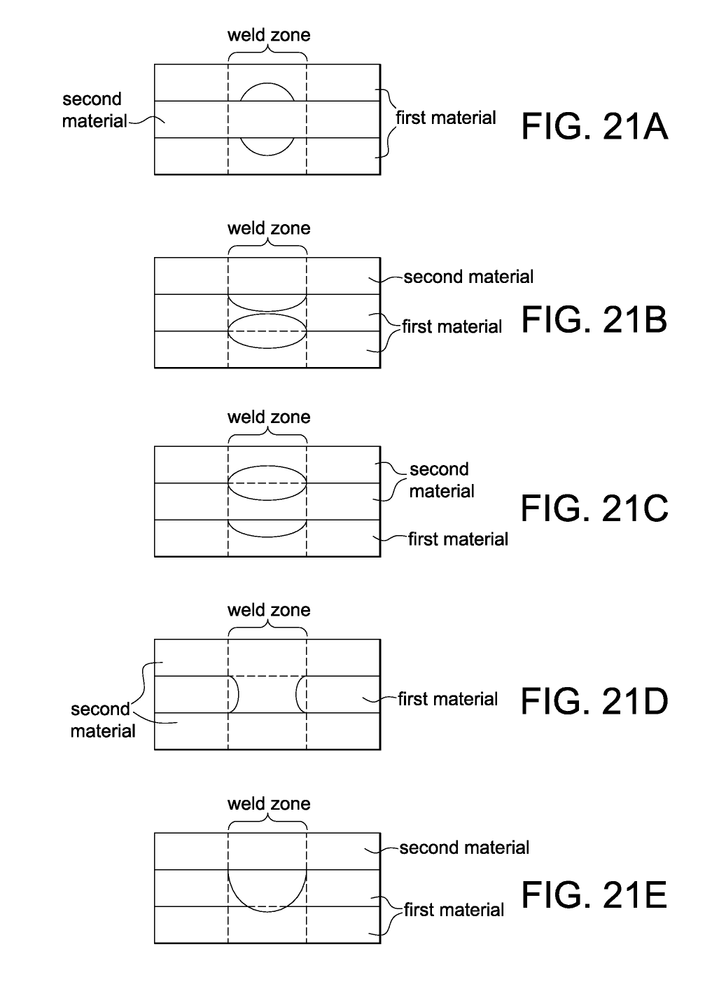

Referring to FIG. 20, a ratio of 1:1 aluminum to steel is depicted. As shown, when no insert is used, the peak temperature is lower than 1000 C. When at least one electrode insert is used (top or bottom) or when both electrode inserts are used, the peak temperature is above 1000 C in these cases (i.e. ranging from around 1050 C to near 1250 C. Without being bound to a particular mechanism or theory, it is believed that when the steel and aluminum are thinner and the ratio is smaller (i.e. the sheets are close to or the same thickness) the electrical conductivity of the steel is able to increase the peak temperature of the weld zone for each of three insert conditions shown. FIG. 20 depicts that the top insert is useful for particular stack-up combinations.

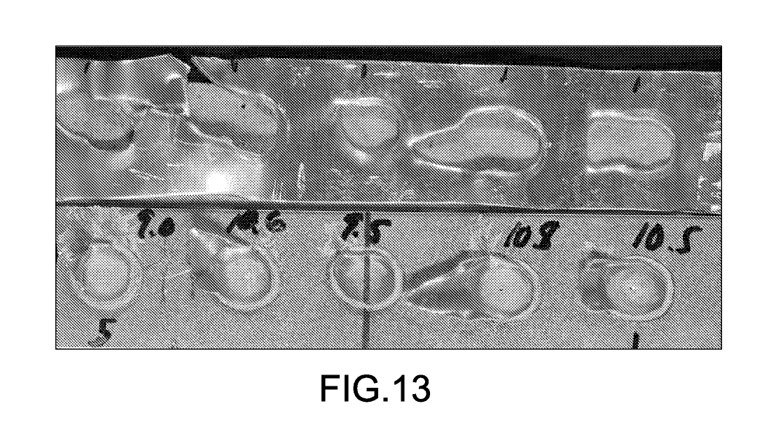

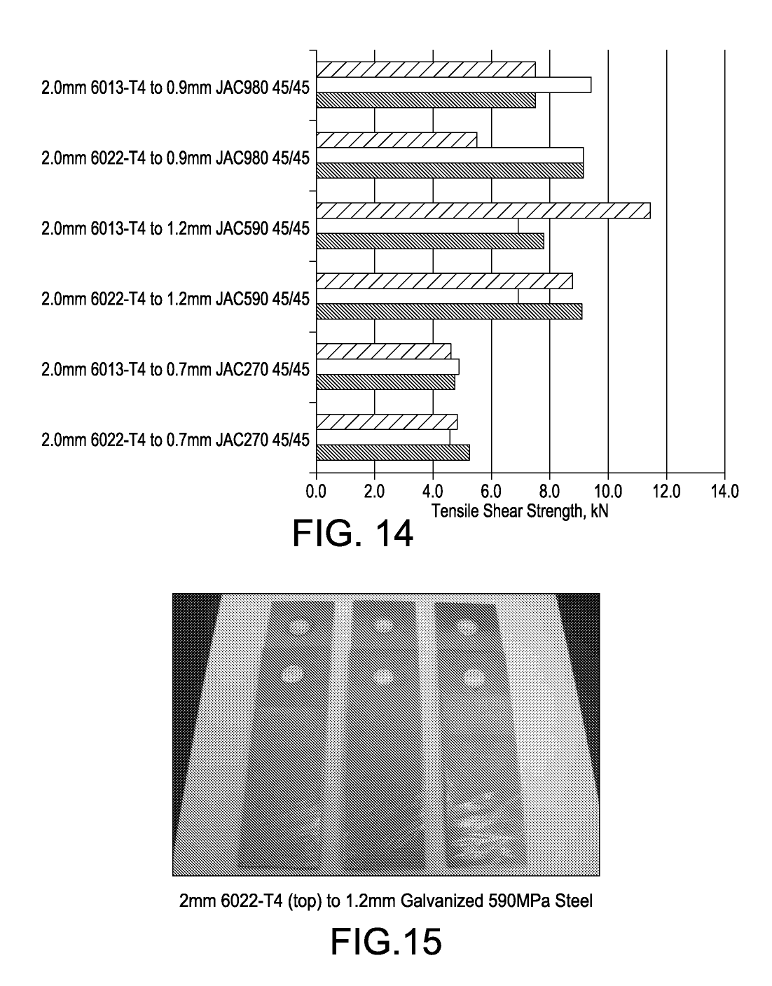

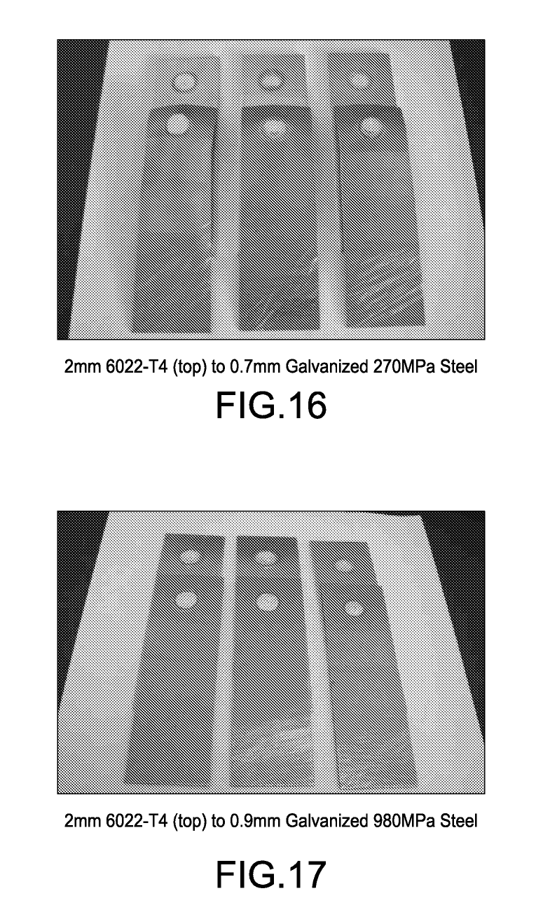

As a result of computer modeling, insert electrodes (shown in FIG. 12) were manufactured according to the geometry shown in FIG. 7 (16 mm body diameter, 6 mm insert thickness). A series of empirical welding trials were conducted and full weld buttons were produced for a variety of aluminum and steel gauge combinations. A picture of one such set of example welds (depicted after peel testing) is shown in FIG. 13. In general, the welding conditions produced welds which were over 9 mm in diameter and yielded cross tension strengths in excess of 1 kN with minimal electrode penetration. Lap shear tensile results are provided in FIG. 14. In this Figure, insert electrodes were employed for both the top and bottom electrodes of various stackups between aluminum and steel. The strengths of the joints varied according to the gauge of the steel welded to the 2 mm aluminum sheets. In general the lap shear strengths of the weld joints met the minimum tensile strengths specified in AWS D17.2 for the aluminum sheet gauges welded. FIGS. 15 through 17 shows photographs of the lap shear specimens for some of the combinations presented in FIG. 14. These photographs show weld interfacial fracture zones exceeding 8 mm in diameters for all the combinations.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. An apparatus, comprising:
a. at least one first sheet comprising a first material;
b. at least one second sheet comprising a second material,
wherein the first material comprises at least one of: a thermal conductivity and an electrical conductivity that is at least 10% lower than that of the second material; and
c. a joint comprising at least one resistance spot weld (RSW), wherein the first sheet is at least about 1.5 times the thickness of the second sheet.

2. The apparatus of claim 1, wherein the RSW has a cross-tension strength of at least about 2.67 kN when measured in accordance with JIS Z3138.

3. The apparatus of claim 1, wherein the first material comprises an aluminum alloy.

4. The apparatus of claim 3, wherein the aluminum alloy is selected form the group consisting of: AA series 1xxx; AA series 2xxx; AA series 3xxx; AA series 5xxx; AA series 6xxx; AA series 7xxx, or combinations thereof.

5. The apparatus of claim 1, wherein the first sheet is selected from the group consisting of: a monolithic aluminum alloy; a multi-layered aluminum alloy; a coated aluminum alloy; a plated aluminum alloy; and combinations thereof.

6. The apparatus of claim 1, wherein the first sheet is not greater than 5 mm.

7. The apparatus of claim 1, wherein the thickness ratio of the first sheet to the second sheet is not greater than 6:1.

8. The apparatus of claim 1 selected from the group consisting of: an auto structure; a body structure; an auto body structure; a closure panel; or combinations thereof.

9. The apparatus of claim 1, wherein the joint comprises a weld bond.

10. The apparatus of claim 1, wherein the cross-tension strength of the RSW is at least about 0.9 kN, as measured in accordance with JIS Z3138.

11. The apparatus of claim 1, wherein the tensile strength of the RSW is at least about 4.45 kN when measured in accordance with JIS Z3138.

12. The apparatus of claim 1, wherein the RSW comprises a weld button pullout range which is: at least about 3 times the square root of the governing gauge, as measured in accordance with JIS Z3140.

13. An apparatus, comprising:
a. at least one first sheet comprising an aluminum alloy;
b. at least one second sheet comprising a non-aluminum material; and
c. a joint comprising at least one RSW configured to join the first sheet to the second sheet, wherein the thickness of the first sheet is greater than the thickness of the second sheet.

14. The apparatus of claim 13, wherein at least one of the first sheet and second sheet comprises a lubricant along a portion thereof.

15. The apparatus of claim 14, wherein the lubricant is selected from the group consisting of: dry film lubricants, water based lubricants, petroleum-based lubricants, and combinations thereof.

16. The apparatus of claim 13, wherein the first material comprises at least one of: a thermal conductivity and an electrical conductivity that is at least 10% lower than that of the second material.

17. The apparatus of claim 13, wherein the second material is selected from the group consisting of: a titanium metal; a titanium alloy; a magnesium metal; a magnesium alloy; a steel alloy; a copper metal; a copper alloy; and combinations thereof.

18. A method, comprising:
overlapping at least one first sheet of a first material with at least one second sheet of a second material, wherein the first material is different than the second material, further wherein the first sheet comprises a thickness ratio of at least 1.5 the thickness of the second sheet;
contacting a pair of electrodes to opposing faces of the first sheet and second sheet to define a weld zone,
wherein at least one of the electrodes comprises an electrode insert having an electrical conductivity of not greater than about 54% IACS;
welding the first sheet to the second sheet across the weld zone to provide at least one resistance spot weld to join the first sheet to the second sheet.

19. The method of claim 18, wherein the contacting step further comprises:
applying a force to the first sheet and second sheet across the weld zone of at least about 2 kN prior to welding.

20. The method of claim 18, wherein the welding step further comprises:
applying a current of not greater than about 45 kA to the weld zone for a weld time of not greater than about 500 milliseconds.
